(19) United States
(12) Patent Application Publication
(10) Pub. No.: US 2025/0000744 A1
(43) Pub. Date: Jan. 2, 2025

(54) AMPOULE FOR ORAL VACCINE ADMINISTRATION AND METHODS OF USE

(71) Applicant: Merck Sharp & Dohme LLC, Rahway, NJ (US)

(72) Inventors: Ramprasad B. Halthore, Chadds Ford, PA (US); Atul Karande, Lansdale, PA (US); Derrick M. Smith, Newtown Square, PA (US)

(73) Assignee: Merck Sharp & Dohme LLC, Rahway, NJ (US)

(21) Appl. No.: 18/710,007

(22) PCT Filed: Nov. 11, 2022
(86) PCT No.: PCT/US2022/049640

§ 371 Date: May 14, 2024

Related U.S. Application Data
(60) Provisional application No. 63/316,047, filed on Mar. 3, 2022.
(60) Provisional application No. 63/279,889, filed on Nov. 16, 2021.

(51) Int. Cl. A61J 1/06; A61J 1/14

(52) U.S. Cl. CPC A61J 1/067; A61J 1/1431; A61J 2205/30

(57) ABSTRACT

An ampoule includes a body having a cavity for storing a medicament, a neck coupled to the body and defining a nozzle in communication with the cavity of the body, a removable cap coupled to the nozzle, and an anti-choking miter coupled to the removable cap, the anti-chocking miter being wider than the removable cap.

### FIELD OF THE DISCLOSURE

The present disclosure relates to containers for vaccine storage and administration. More particularly the present disclosure relates to ampoules for delivery of medicaments to patients, and in particular embodiments the oral delivery of medicaments to patients.

### BACKGROUND OF THE DISCLOSURE

Glass vials are commonly used to store vaccines, biologics, medicaments, and the like. Syringes are used to extract the contents of the vials and administer the medicament to the patient. Pre-filled syringes may also be used. Such syringes typically utilize parenteral routes (e.g., injecting directly into the body, bypassing the skin and mucous membranes), and are administered by a physician or healthcare provider. Recently, automatic injection devices (commonly known as “autoinjectors”) have been used to simplify the administration of drugs in certain settings. Due to their simplicity of design, autoinjectors allow patients to use the devices on themselves reliably and safely, and in their own home without supervision.

Certain patients may experience pain or fear of needles while using conventional syringes and autoinjectors, especially in multi-dosage treatments, and recurring therapeutic applications. Additionally, conventional devices may not be able to allow for proper sustained drug release, and may not be suitable for patients of all ages.

Thus, there exists a need for devices that improve upon and advance the methods of delivering drugs and medicaments to patients in a safe, comfortable and controlled manner.

### SUMMARY OF THE DISCLOSURE

In specific embodiments, the ampoules described herein include a body having a cavity for storing a medicament, a neck coupled to the body and defining a nozzle in communication with the cavity of the body, a removable cap coupled to the nozzle, and an anti-choking miter coupled to the removable cap, the anti-chocking miter being wider than the removable cap.

### BRIEF DESCRIPTION OF THE DISCLOSURE

Various embodiments of the presently disclosed ampoules are disclosed herein with reference to the drawings, wherein:

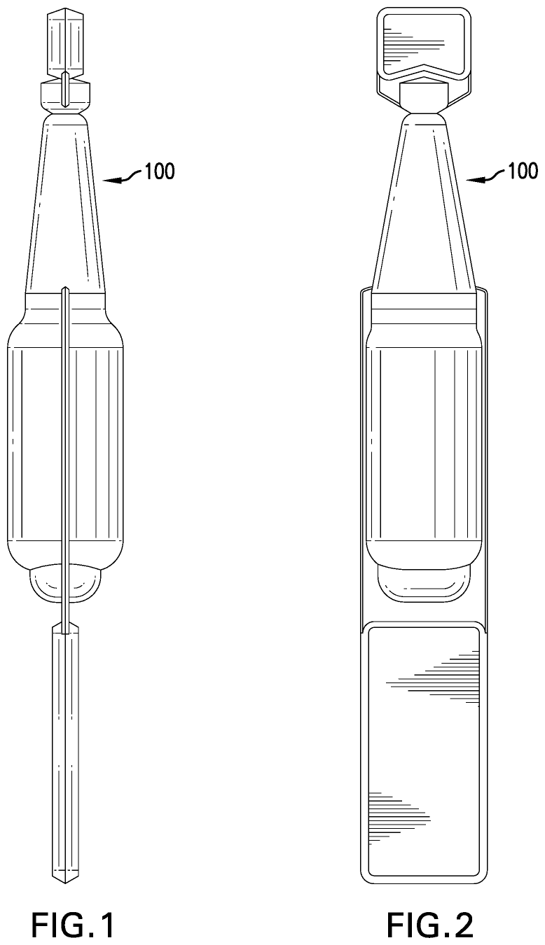

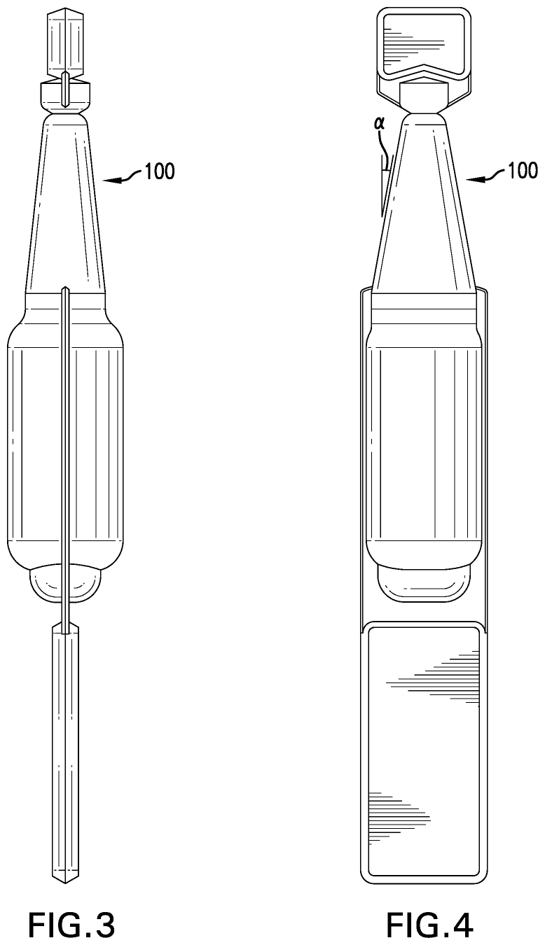

FIGS. 1-7 are schematic left, front, right, back, perspective, top and bottom views of a first embodiment of an ampoule, respectively;

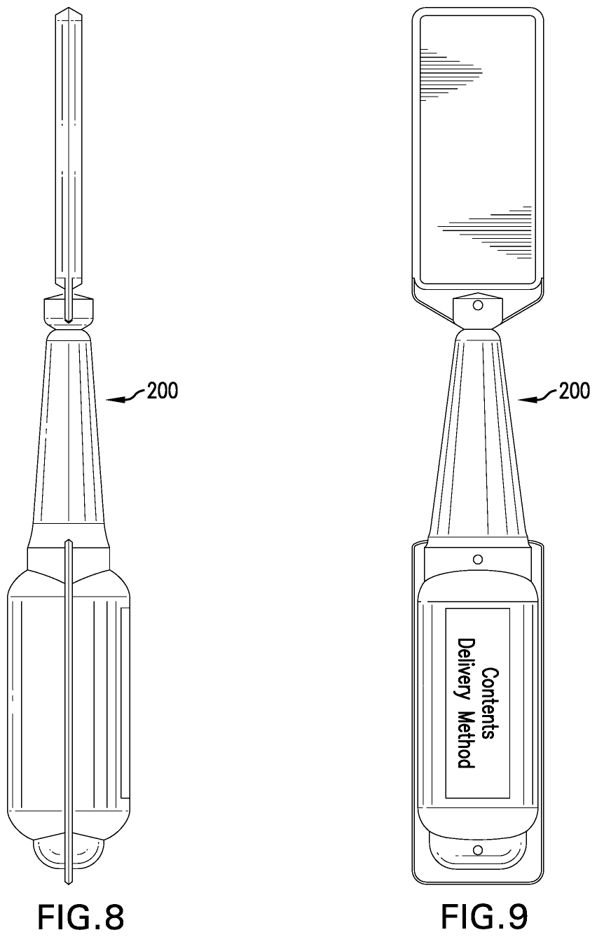

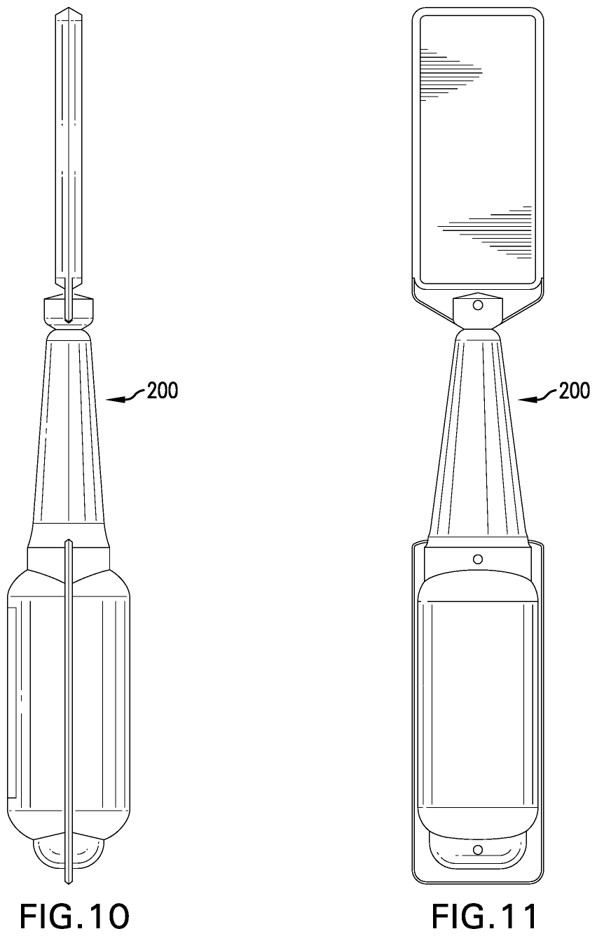

FIGS. 8-14 are schematic left, front, right, back, perspective, top and bottom views of a second embodiment of an ampoule, respectively;

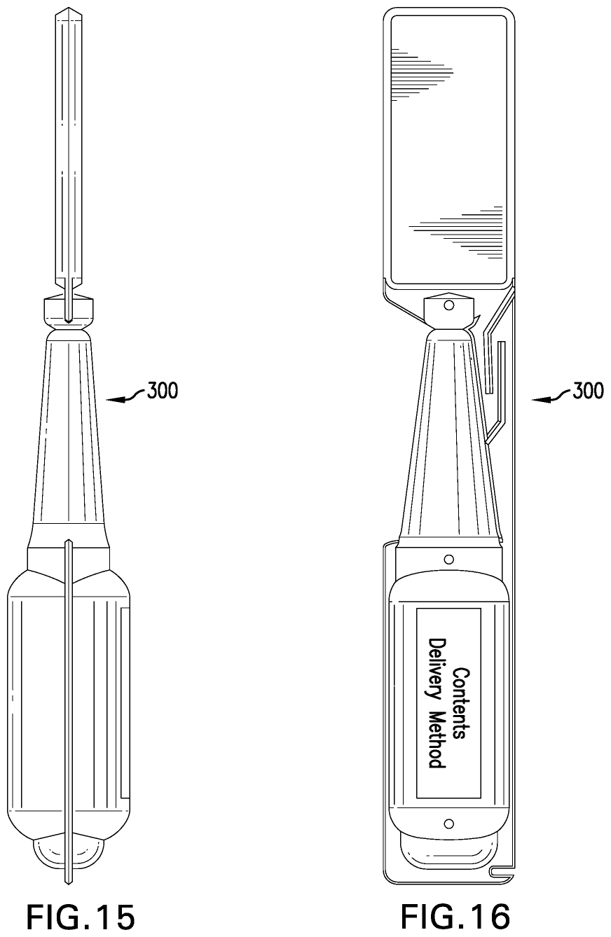

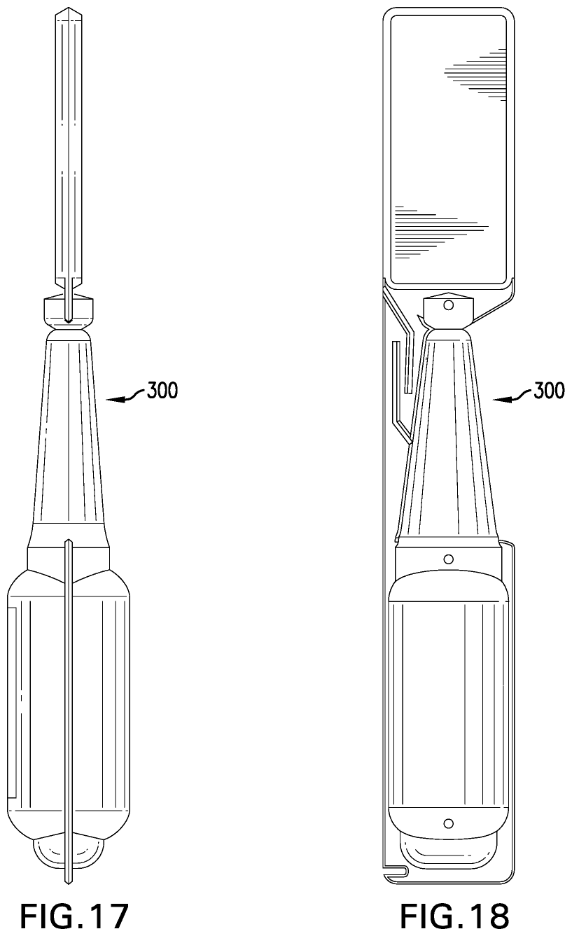

FIGS. 15-21 are schematic left, front, right, back, perspective, top and bottom views of a third embodiment of an ampoule, respectively;

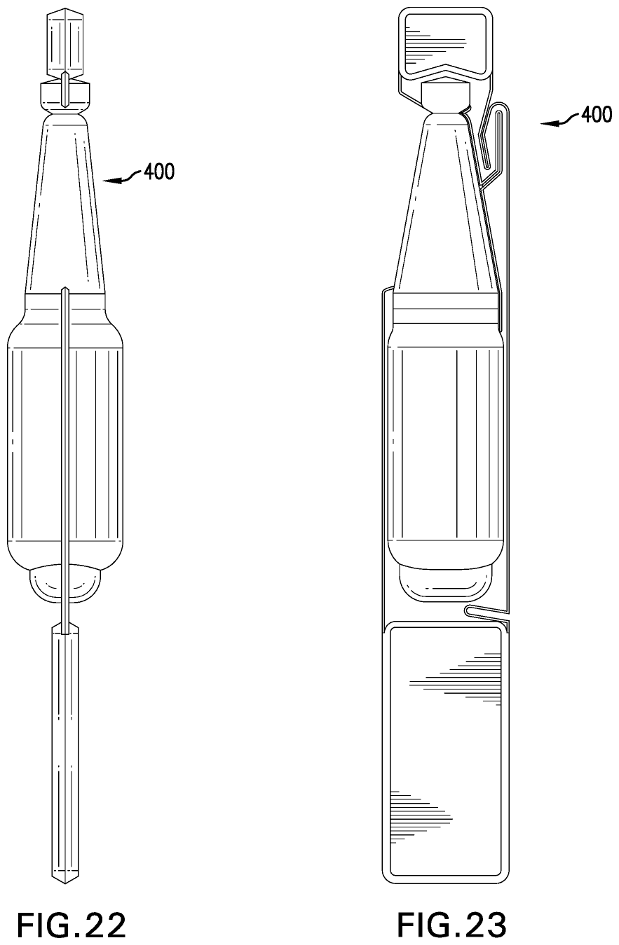

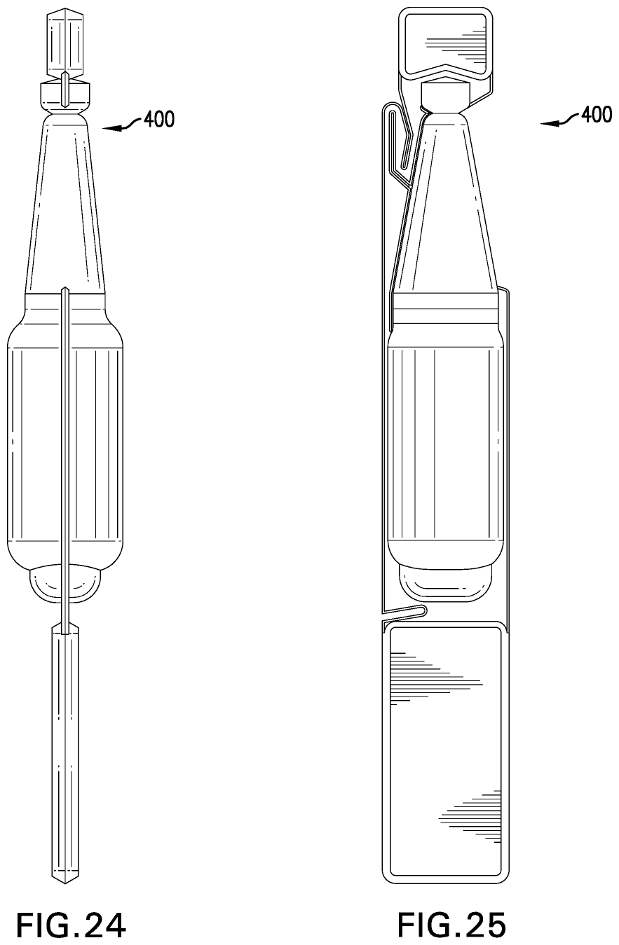

FIGS. 22-28 are schematic left, front, right, back, perspective, top and bottom views of a fourth embodiment of an ampoule, respectively;

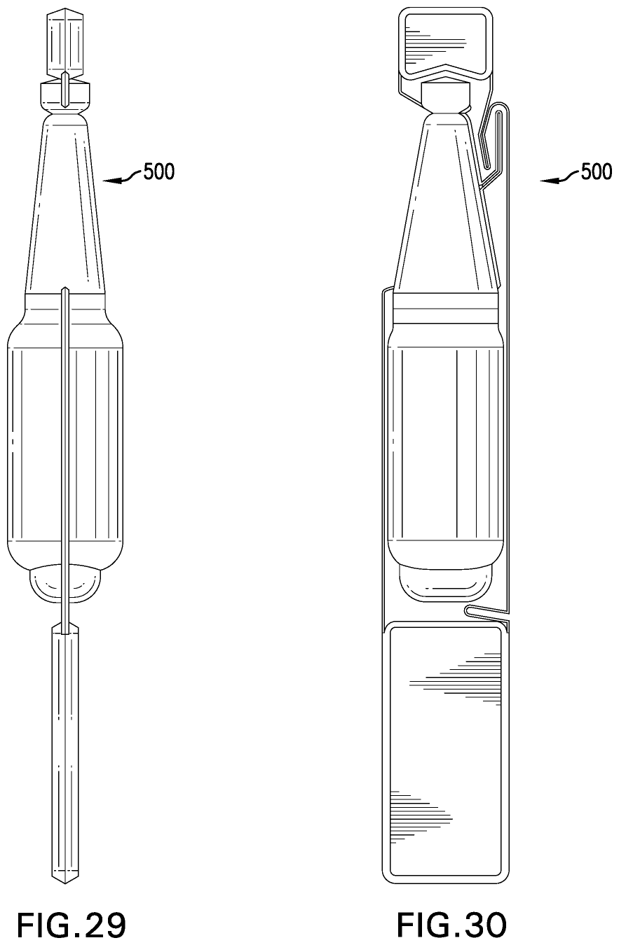

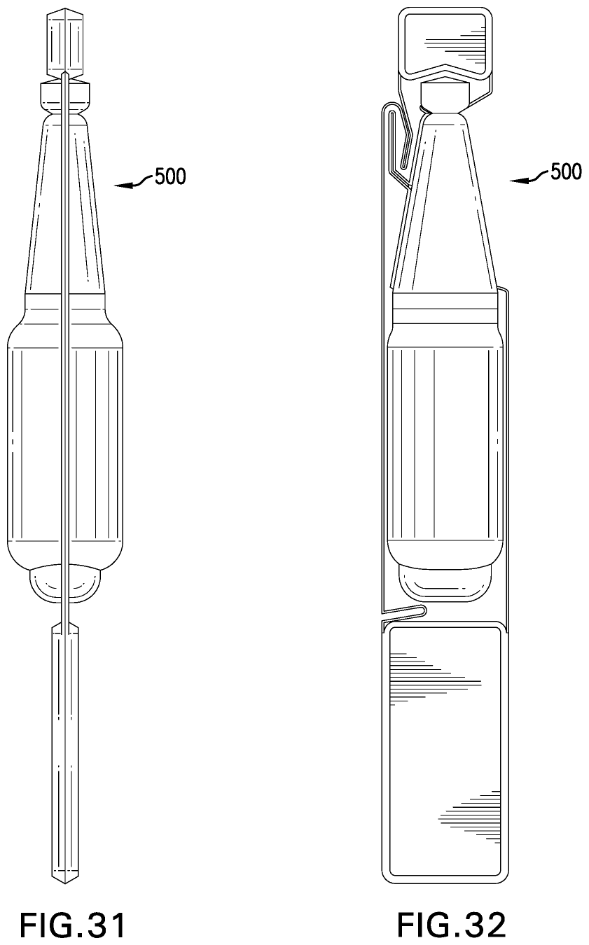

FIGS. 29-35 are schematic left, front, right, back, perspective, top and bottom views of a fifth embodiment of an ampoule, respectively;

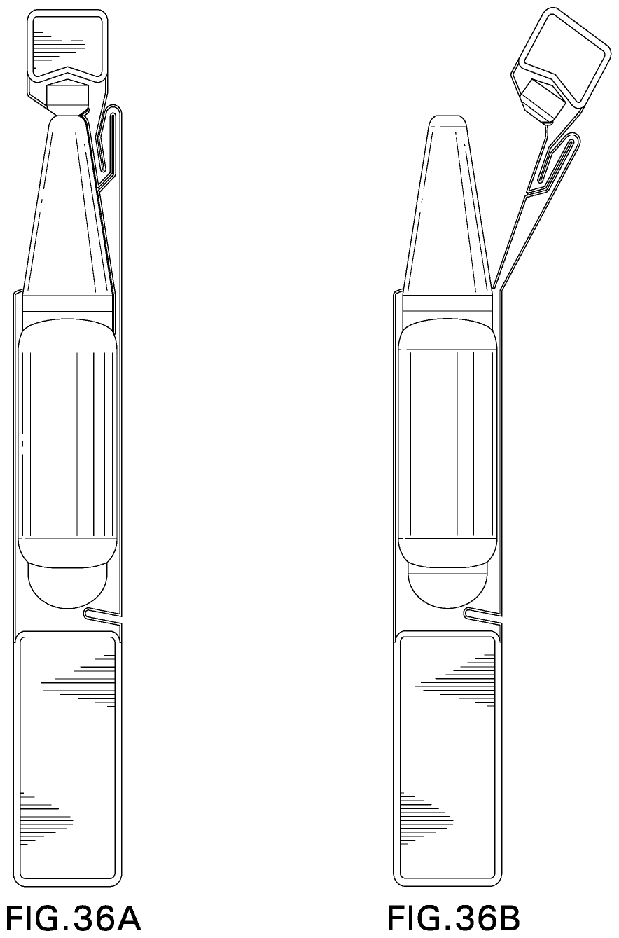

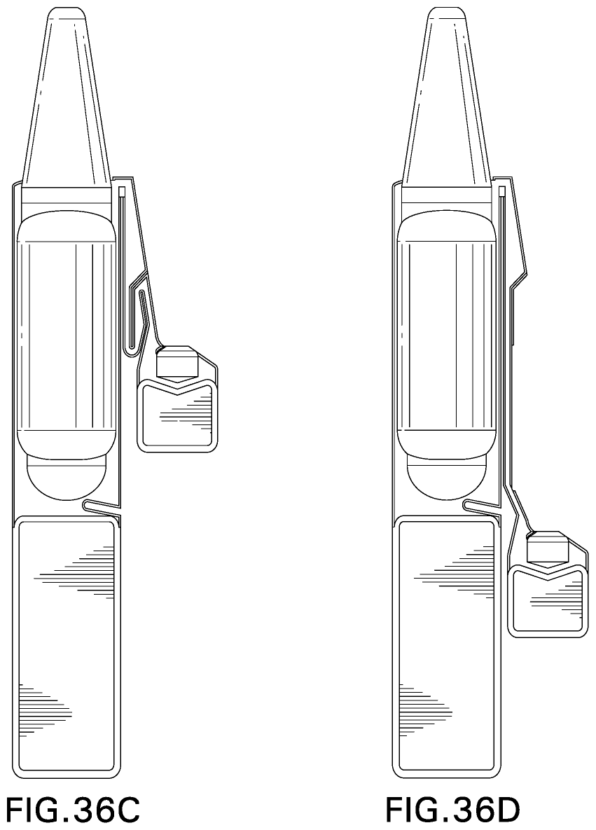

FIGS. 36A-D illustrate the use of an ampoule having an arm to space a cap away from an exposed nozzle; and

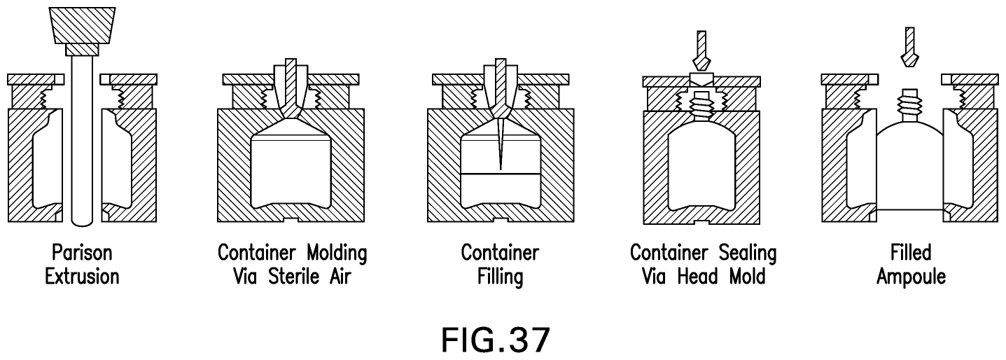

FIG. 37 illustrates a method of forming an ampoule using blow-fill sealing.

Various embodiments of the present invention will now be described with reference to the appended drawings. It is to be appreciated that these drawings depict only some embodiments which may or may not all be required for functionality of the invention and are therefore not to be considered limiting of its scope.

### DETAILED DESCRIPTION

Despite the various improvements that have been made to drug delivery, conventional devices suffer from some shortcomings as described above.

There therefore is a need for further improvements to the devices, systems, and methods of delivering medicaments. Among other advantages, the present disclosure may address one or more of these critical needs.

As used herein, the term “proximal,” when used in connection with a component of an ampoule, refers to the end of the component closest to the site of administration, e.g., the patient's mouth, when the ampoule is being administered to a patient, whereas the term “distal,” when used in connection with a component of an ampoule, refers to the end of the component farthest from the site of administration. As used herein, the terms “medicament,” “medication,” and “drug” are used generically interchangeably and it will be understood that the ampoules described herein may be used to store, deliver or administer vaccines, biologics, therapeutic, medicaments, topical ointments, and the like.

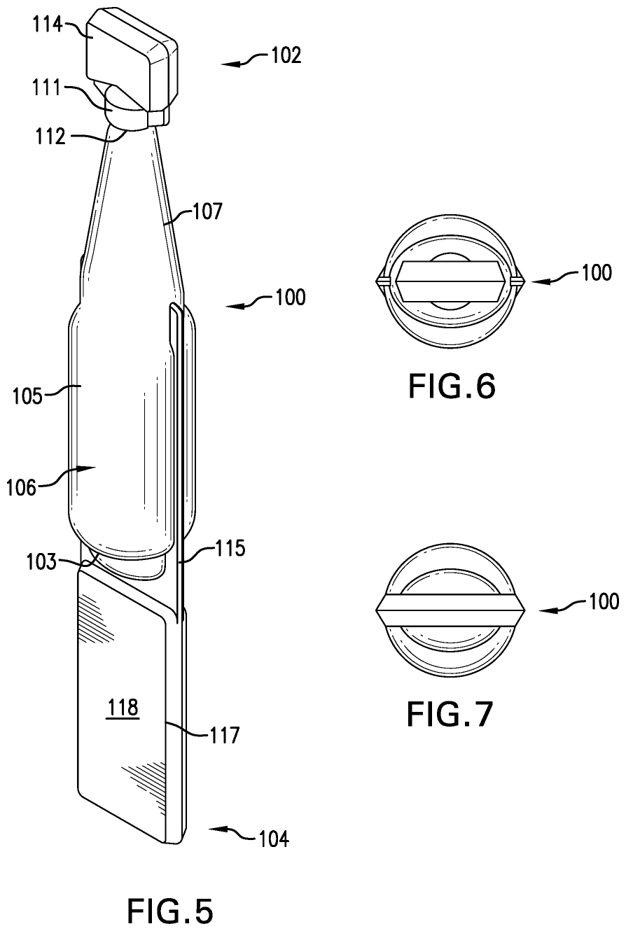

As shown in FIGS. 1-7, a first embodiment of an ampoule 100 will be described. As best shown in FIG. 5, ampoule 100 may extend between a proximal end 102 and a distal end 104, and may be entirely formed of a polymer. In specific embodiments, the ampoules described herein may include polyolefins, such as Low-Density Polyethylene (LDPE) material, which can be flexible and able to administer a medicament when squeezed. In specific embodiments, the ampoules described herein are made of a translucent material (i.e., one that allows light to at least partially pass therethrough) that allows the user to at least partially see its contents. In specific embodiments, the ampoules described herein may have a predetermined opacity of 90%, 80%, 70%, 60%, 50%, 40%, 30%, 20% or 10%. The methods of forming ampoule 100 will be described in greater detail below. Generally, ampoule 100 may include a base 103, a body 105 defining an inner cavity 106, a tapered neck 107 connected to the body and leading to a cap 111, the cap fitted on nozzle 112. In specific embodiments, the nozzles described herein may be disposed at the interface between the bottom of cap 111 and the top of neck 107. The inner diameter of nozzle 112 may be chosen based on a desired fluid flow speed. Too small a nozzle increases the delivery time and too large a nozzle may result in high fluid flow and present a choking hazard to infants. In specific embodiments, the nozzles described herein may have a diameter of between 0.2 mm and 2 mm. Nozzle 112 may form a predetermined percentage of the total surface area of the top of neck 107 (e.g., nozzle may form less than 2%, 2-5%, 5-10%, 10-20%, 20-30%, or more than 30% of the surface area of the top of neck 107). Cap 111 may be removably coupled to nozzle 112. In specific embodiments, the caps described herein may be scored or define a weakened portion at its base so that the cap may be twisted and separated from the rest of the ampoule to expose nozzle 112.

Medicament may be disposed inside cavity 106 of body 105, which may define a continuous passage through neck 107 and out of nozzle 112. As shown in FIGS. 1-7, cap 111 may be coupled to an anti-choking mechanism in the form of a miter 114, the miter having a width that is greater than the width of cap 111. In specific embodiments, the miters described herein are generally rectangular. Alternatively, miters may be circular, oval or butterfly-shaped. Miters may be 13-15 mm in width and 10-15 mm in length. Miters may be 25%, 30%, 40%, 50%, 75%, 100% or more wider than cap 111. In specific embodiments, the miters described herein are sized so that they will not pose a choking hazard to an infant. Cap 111 and miter 114 may be coupled together, or unitarily formed, so that the cap and miter remain together when the cap 111 is removed from the rest of the ampoule to expose the nozzle 112.

Optionally, the ampoule may include one or more flattened shoulders 115 coupled to, and extending around portions of, body 105. Shoulders 115 may also be coupled to platform 117. Platform 117 may be rectangular as shown, or circular, triangular or any other desired shape. In specific embodiments, the platforms described herein include a flattened surface 118 capable of accepting an adhesive label that includes text or symbols to signify the contents of the ampoule, dosing instructions, adverse side effects, manufacturer, lot number, or other identifying or patient-specific information.

To administer medication, a user (e.g., patient or operator) may remove cap 111 from the ampoule 100 to expose the nozzle 112 by twisting, bending or otherwise tearing the cap from neck 107. The user may then place the nozzle inside the patient's mouth or alternative site of administration and squeeze the flexible walls of the body together adjacent the cavity to eject the contents of the ampoule cavity into the site of administration or mouth if oral dosing is intended. In specific embodiments, the medication may be ejected onto another body part as indicated by the medication. Thus, though delivery to the mouth is being primarily described, other delivery routes are also possible including nasal administration, eye (i.e., drops), rectal, vaginal, ear, etc. These delivery routes are also applicable to all embodiments described in this disclosure. Because the miter 114 remains attached to cap 111 at all times, the ampoule may be used with infants and children without posing a choking risk from the separated cap. The neck and specifically the taper of the neck may have a length and/or width determined based on an intended delivery route (e.g., infant cheek) and the angle of taper may be chosen based on the delivery route. For example, necks described herein may have a length greater than 15 mm (e.g., 25 mm, 26 mm, 27 mm, 28 mm, 29 mm, 30 mm or greater), and a gradually narrowing width that is linearly, or non-linearly reduced from 15 mm at its base (i.e., closest to body 105) to 5 mm or less at its crown closest to cap 111. Overall, the shape of the neck may be substantially conical, and the neck may be angled with respect to the longitudinal axis at a neck angle α of between 5 degrees to 20 degrees (e.g., between 5 and 10 degrees, or at an angle of 8 degrees). The neck angle α is best shown in FIG. 4, but it will be understood that any of the features disclosed throughout the instant disclosure with respect to one embodiment, may be equally applicable to other embodiments.

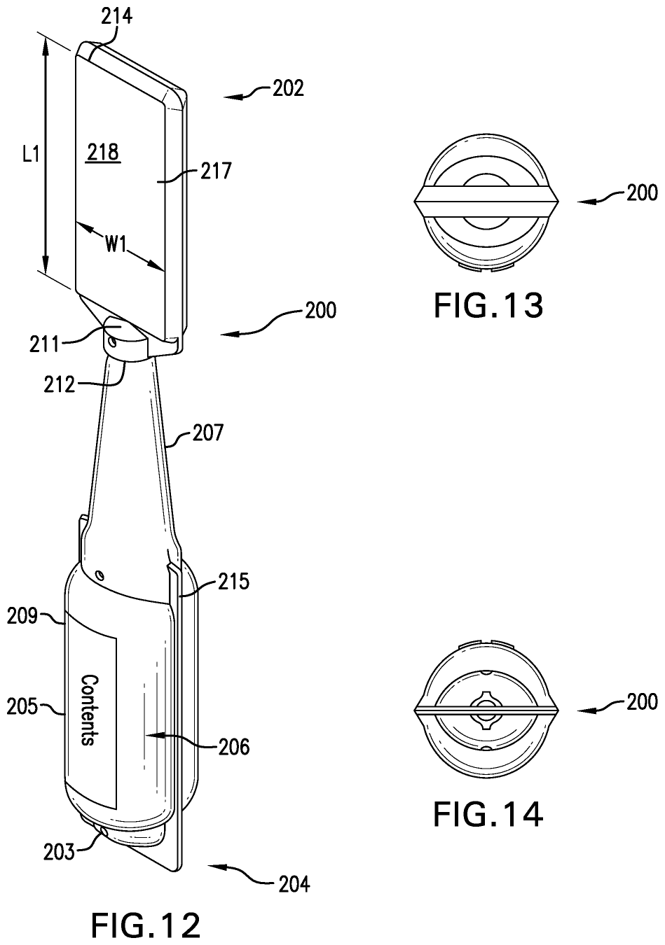

A second embodiment of an ampoule 200 is shown in FIGS. 8-14. As best shown in FIG. 12, ampoule 200 may extend between a proximal end 202 and a distal end 204, and may be entirely formed of polymer such as those described above. Generally, ampoule 200 may include a base 203, a body 205 defining an inner cavity 206, a tapered neck 207 connected to the body 205 and leading to a cap 211, the cap fitted on nozzle 212. In this example, an embossed label 209 is shown on body 205. The embossed label 209 may be an optional feature and may be combined with any of the other embodiments described in this disclosure. Embossed label 209 may include text or symbols to signify the contents of the ampoule, dosing instructions, adverse side effects, manufacturer, lot number, or other identifying or patient-specific information. Cap 211 may be removably coupled to nozzle 212 as previously described. In this example, ampoule 200 includes a miter 214 that may serve as both an anti-choking mechanism and as a flattened surface 218 or platform 217 for receiving a label. In specific embodiments, the miters described herein are generally rectangular and have a length L1 that is greater than width W1. In specific embodiments, the miters described herein have a length L1 greater than 15 mm (e.g., 25 mm, 26 mm, 27 mm, 28 mm, 29 mm, 30 mm or greater), and a width W1 of 13-15 mm. Miter 214 may have a width W1 that is greater than the width of cap 211. Miter 214 may be 25%, 30%, 40%, 50%, 75%, 100% or more wider than cap 211. In specific embodiments, the miters described herein are sized so that they will not pose a choking hazard to an infant. Cap 211 and miter 214 may be coupled together, or unitarily formed, so that the cap and miter remain together when the cap 211 is removed from the rest of the ampoule to expose the nozzle 212. Optionally, the ampoule may include one or more flattened shoulders 215 coupled to body 205. Ampoule 200 may be used in the same way as ampoule 100 by removing the cap 211 and miter 214 from the rest of the ampoule and squeezing the walls of the body 205 to administer the medication out of the nozzle 212.

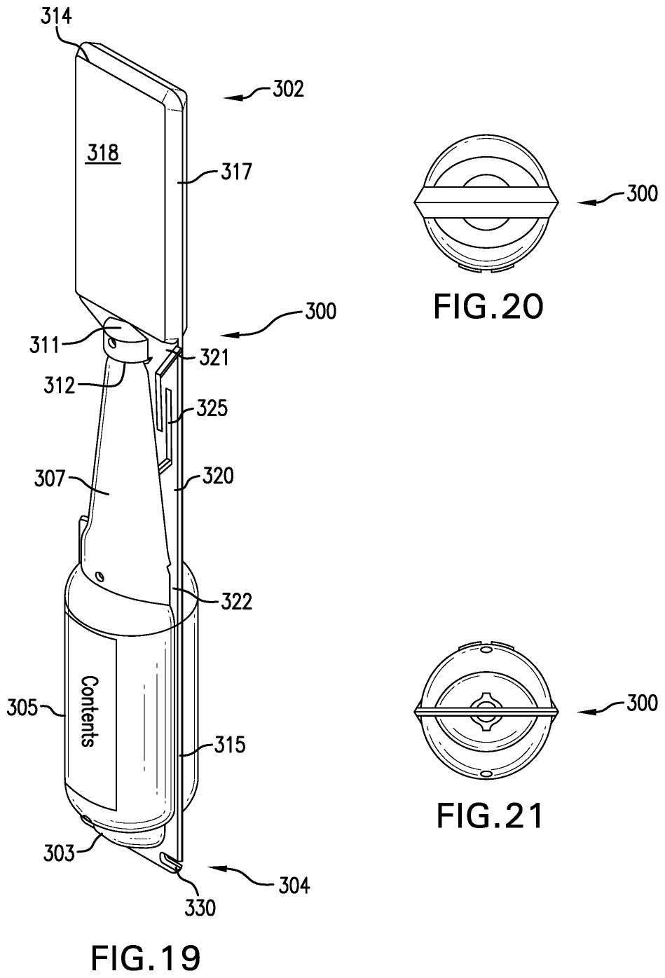

A third embodiment of an ampoule 300 is shown in FIGS. 15-21 and is similar to the second embodiment in most ways except for the addition of a retaining mechanism. Each of the elements 300-315 shown in FIG. 19 correspond to like-numbered elements 200-215 shown in FIG. 12, which have been described previously. In this example, ampoule 300 includes a miter 314 that may serve as both an anti-choking mechanism and as a platform 317 or flattened surface 318 for receiving a label. In this embodiment, miter 314 and/or cap 311 are coupled to body 305 or shoulder 315 via an arm 320. Specifically, in the example shown, a serpentine arm 320 connects the miter and/or the cap at a first end 321, and to a lower portion of neck 307 and/or to body 305 at a second end 322. A channel 325 runs along a portion of neck 307 and may be disposed between portions of arm 320 to space the miter and cap from the body when the cap is removed from ampoule 300. Ampoule 300 further includes a lower notch 330 formed adjacent the lower portion of shoulder 315, the notch being wide enough to receive a portion of miter 314 or arm 320.

The use of ampoule 300 to administer medication is similar to the procedure described above with respect to ampoule 100 with some exceptions. First, a user (e.g., patient or operator) may remove cap 311 from the ampoule 300 to expose the nozzle 312 by twisting, bending or otherwise tearing the cap from the neck 307. In this example, the cap 311 remains attached to the miter 314 and to body 305 at second end 322, but the arm may be stretched to further space the cap from nozzle 312. FIGS. 36A-D illustrate the removal of the cap and miter of one similar embodiment, and the extension of arm 320 to keep the cap away from the exposed nozzle. Optionally, the user may slide a portion of miter 314 or arm 320 into notch 330 to retain the miter and cap adjacent the distal end of the device. The user may then place the nozzle inside the patient's mouth or alternative site of administration and squeeze the flexible walls of the body together adjacent the cavity to eject the contents of the ampoule into the site of administration or mouth if oral dosing is intended. Because the enlarged miter 314 and cap 311 remain attached to body 305 at the distal end of the device, the ampoule may be used with infants and children without posing a choking risk from the separated cap.

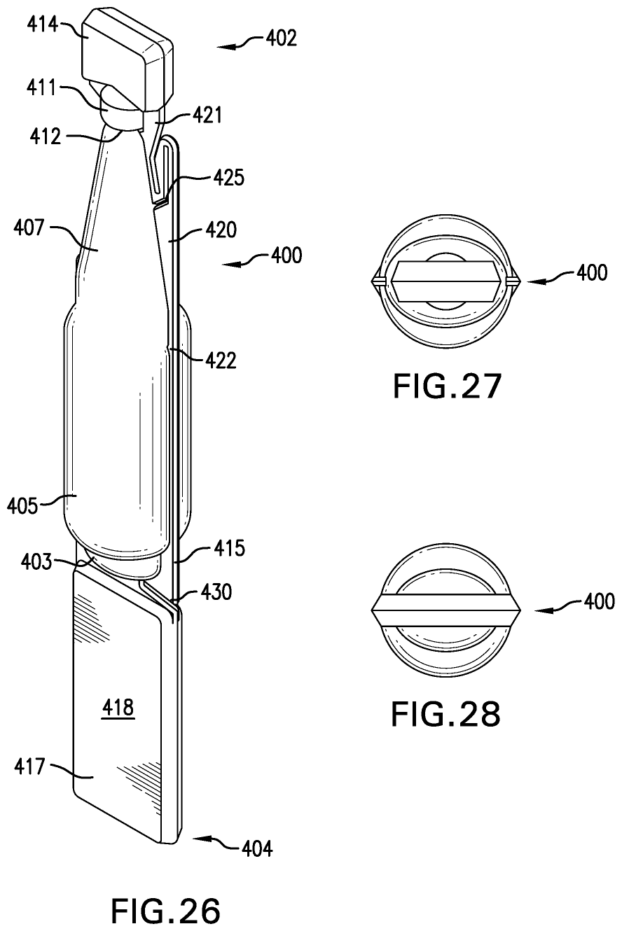

A fourth embodiment of an ampoule 400 is shown in FIGS. 22-28. Each of the elements 400-415 shown in FIG. 26 correspond to like-numbered elements 200-215 shown in FIG. 12, which have been described previously. Notably, ampoule 400 includes a miter 414 that is similar to miter 114, and includes a lower platform 417 or flattened surface 418, and a lower notch 430 disposed above the lower platform or flattened surface. In this example, arm 420 is connected at a first end 421 to miter 414, and to a second end 422 at the junction of body 405 and neck 407. Ampoule 400 may be used in a manner similar to that described above by twisting the cap 411 and retaining a portion of the miter 414 or arm 420 in lower notch 422.

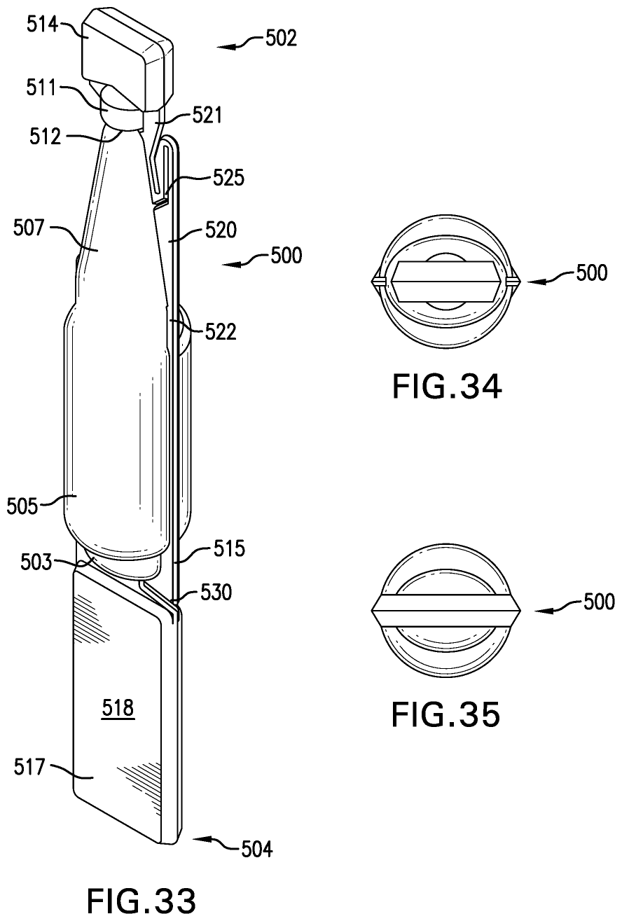

A fifth embodiment of an ampoule 500 is shown in FIGS. 29-35. Each of the elements 500-515 shown in FIG. 33 correspond to like-numbered elements 200-215 shown in FIG. 12, which have been described previously. Ampoule 500 includes a miter 514 that is similar to miter 114, and includes a lower platform 517 or flattened surface 518, and a lower notch 530 disposed above the lower platform or flattened surface. In this example, arm 520 is connected at a first end 521 to miter 514, and to a second end 522 at the junction of body 505 and neck 507. Ampoule 500 may be used in a manner similar to that described above by twisting the cap 511 and retaining a portion of the miter 514 or arm 520 in lower notch 522. Ampoule 500 is similar to ampoule 400 in every way except that channel 525 extends along the length of neck 507 to second end 522, and terminates closer to the proximal end of the device adjacent the neck and does not continue down to the body.

In use, the ampoules described above may be used by the administrator to deliver pre-determined filled quantities of a drug through the mouth or alternative site of administration. The length of the neck of the ampoule may provide for safe and effective oral delivery to patients (e.g., 6 weeks old infants). Various labelling options are provided, including embossed labels on the body of the device or through the use of adhesive labels or laser etching on the ampoule body and/or platform.

In specific embodiments, the ampoules described herein may be mass produced using blow-fill sealing. A schematic of blow-fill sealing technology is shown in FIG. 37. Blow-fill sealing is a pharmaceutical filling process in which the primary packaging container is formed from an extruded thermoplastic parison, filled with product, and sealed in a continuous, integrated, automated operation. It has been referred to as an “advanced aseptic fill-seal technique” by the United States Food and Drug Administration (FDA) and United States Pharmacopeia (USP) due to its minimal human intervention. One advantage of blow-fill sealing over “traditional” aseptic filling operations is that personnel are not normally present in the filling area, thereby removing a potential source of microbial contamination. Instead, containers are formed immediately before filling, filled under controlled conditions, and sealed immediately after filling. The blow-fill sealing machine output may be dependent upon product and polymer (resin) physical characteristics and container design, and the cycle time may be dependent upon the product filling characteristics (e.g., viscosity, foaming) and the resin-dependent formation time required in the mold.

Specific embodiments of the present invention include:
a. Embodiment 1: An ampoule comprising:
a body having a cavity for storing a medicament;
a neck coupled to the body and defining a nozzle in communication with the cavity of the body;
a removable cap coupled to the nozzle; and
an anti-choking miter coupled to the removable cap, the anti-chocking miter being wider than the removable cap.
b. Embodiment 2. The ampoule of Embodiment 1, wherein the neck is tapered.
c. Embodiment 3. The ampoule of any of Embodiments 1-2, wherein the cap is configured and arranged to twist-off the nozzle.
d. Embodiment 4. The ampoule of any one of Embodiments 1-3, wherein the miter is rectangular.
e. Embodiment 5. The ampoule of any one of Embodiments 1-4, further comprising an arm coupled to the miter at a first end and to the body at a second end.
f. Embodiment 6. The ampoule of Embodiment 5, further comprising a channel defined between the arm and the neck.
g. Embodiment 7. The ampoule of Embodiment 6, wherein the channel extends along at least a portion of the body.
h. Embodiment 8. The ampoule of Embodiment 6, wherein the channel extends between two portions of the arm.
i. Embodiment 9. The ampoule of any one of Embodiments 1-8, further comprising at least one flattened shoulder coupled to at least one neck and the body.
j. Embodiment 10. The ampoule of Embodiment 9, further comprising a notch defined in the at least one flattened shoulder.
k. Embodiment 11. The ampoule of any one of Embodiments 1-10, further comprising a platform coupled body and disposed distal to the body.
l. Embodiment 12. The ampoule of Embodiment 11, further comprising a label disposed on the platform.
m. Embodiment 13. The ampoule of any one of Embodiments 1-12, wherein the body comprises a polymer.
n. Embodiment 14. The ampoule of any one of Embodiments 1-13, wherein the body is formed via blow-fill-sealing.
o. Embodiment 15. An ampoule comprising:
a body having a cavity for storing a medicament;
a neck coupled to the body and defining a nozzle in communication with the cavity of the body;
a removable cap coupled to the nozzle;
an anti-choking miter coupled to the removable cap, the anti-chocking miter being wider than the removable cap; and
an arm coupled to the miter at a first end and to the body at a second end.
p. Embodiment 16. The ampoule of Embodiment 15, further comprising a channel defined between the arm and the neck.
q. Embodiment 17. The ampoule of Embodiment 16, wherein the channel extends along at least a portion of the body.
r. Embodiment 18. The ampoule of Embodiment 16, wherein the channel extends between two portions of the arm.
s. Embodiment 19. The ampoule of Embodiment 15, further comprising at least one flattened shoulder coupled to at least one neck and the body.
t. Embodiment 20. A method of forming an ampoule comprising:
extruding a parison;
molding the ampoule from the parison via sterile air, the ampoule including a body having a cavity for storing a medicament, a neck coupled to the body and defining a nozzle in communication with the cavity of the body, a removable cap coupled to the nozzle, and an anti-choking miter coupled to the removable cap, the anti-chocking miter being wider than the removable cap; and
filling the cavity of the body with a medicament.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

1. An ampoule comprising:
a body having a cavity for storing a medicament;
a neck coupled to the body and defining a nozzle in communication with the cavity of the body;
a removable cap coupled to the nozzle; and
an anti-choking miter coupled to the removable cap, the anti-chocking miter being wider than the removable cap.

2. The ampoule of claim 1, wherein the neck is tapered.

3. The ampoule of claim 1, wherein the cap is configured and arranged to twist-off the nozzle.

4. The ampoule of claim 1, wherein the miter is rectangular.

5. The ampoule of claim 1, further comprising an arm coupled to the miter at a first end and to the body at a second end.

6. The ampoule of claim 5, further comprising a channel defined between the arm and the neck.

7. The ampoule of claim 6, wherein the channel extends along at least a portion of the body.

8. The ampoule of claim 6, wherein the channel extends between two portions of the arm.

9. The ampoule of claim 1, further comprising at least one flattened shoulder coupled to at least one neck and the body.

10. The ampoule of claim 9, further comprising a notch defined in the at least one flattened shoulder.

11. The ampoule of claim 1, further comprising a platform coupled to the body and disposed distal to the body.

12. The ampoule of claim 11, further comprising a label disposed on the platform.

13. The ampoule of claim 1, wherein the body comprises a polymer.

14. The ampoule of claim 1, wherein the body is formed via blow-fill-sealing.

15. An ampoule comprising:
a body having a cavity for storing a medicament;
a neck coupled to the body and defining a nozzle in communication with the cavity of the body;
a removable cap coupled to the nozzle;
an anti-choking miter coupled to the removable cap, the anti-chocking miter being wider than the removable cap; and
an arm coupled to the miter at a first end and to the body at a second end.

16. The ampoule of claim 15, further comprising a channel defined between the arm and the neck.

17. The ampoule of claim 16, wherein the channel extends along at least a portion of the body.

18. The ampoule of claim 16, wherein the channel extends between two portions of the arm.

19. The ampoule of claim 15, further comprising at least one flattened shoulder coupled to at least one neck and the body.

20. A method of forming an ampoule comprising:
extruding a parison;
molding the ampoule from the parison via sterile air, the ampoule including a body having a cavity for storing a medicament, a neck coupled to the body and defining a nozzle in communication with the cavity of the body, a removable cap coupled to the nozzle, and an anti-choking miter coupled to the removable cap, the anti-chocking miter being wider than the removable cap; and
filling the cavity of the body with a medicament.
